(19) United States
(12) Patent Application Publication
(10) Pub. No.: US 2011/0024470 A1
(43) Pub. Date: Feb. 3, 2011

(54) Handheld device holder for vehicle's steering wheel

(76) Inventor: Hamid Cyrus Hajarian, Laguna Niguel, CA (US)

Correspondence Address: Hamid C. Hajarian, 27741 Agate Canyon Drive, Laguna Niguel, CA, 92677, US

(21) Appl. No.: 12/804,815

(22) Filed: Jul. 29, 2010

Related U.S. Application Data
(60) Provisional application No. 61/273,297, filed on Aug. 3, 2009.

(51) Int. Cl. B60R 7/04

(52) U.S. Cl. 224/276

(57) ABSTRACT

A handheld device holder is placed over vehicle's steering wheel. This device provide hands free operation for a handheld device in which the driver's hands fully positions on steering wheel and driver have full attention to the road while driving. The holder apparatus include a rotatable platform which attachably connected to a base via a magnet or clips.

Applicant claim priority-filling date for this application. Provisional application filed on Aug. 3, 2009, and the application Ser. No. 61/273,297.

### FIELD OF THE INVENTION

The present invention relates to a handheld device holder. More particularly the holder apparatus is for vehicle's steering wheel.

### BACKGROUND OF THE INVENTION

There is variety of holders to hold handheld devices such as cell phones, navigation devices, media player devices, mini laptop etc. The holders come in many forms and shape to be used in vehicle and may be attached to the cigarette lighter or located in the dashboard or onto the windshield, or placed in center console. Because of the routine driver interaction with handheld devices, the prior art holders are away from driver and far from driver's direct sight. For example once a cell phone is placed into its holder in the car, it cannot be used to answer a call or make a call, without great distraction and without fully holding the device in the palm of one hand thus rendering that hand useless for driving. Other problems may include minimal ability to use the device for viewing, dialing, and other key functions on handheld device.

However, this invention overcomes the shortcomings and solving some of the problems associated with prior art handheld device holder. This invention place a holder onto the center of the vehicle's steering wheel in which provides direct interaction for driver without any vision distraction that is necessary to watch the road.

### SUMMARY OF THE INVENTION

It is an object of the present invention to provide a holder for a handheld device to be placed over center portion of the vehicle's steering wheel. This device provide hands free operation for a handheld device in which the driver's hands fully positions on steering wheel and driver have full attention to the road while driving. This handheld device holder does not require any more attention or action than other modules such as standard cruise control or volume control modules on modern steering wheels as standard modalities. The holder apparatus include a rotatable platform which attachably connected to a base via a magnet, or clip-on. The base is adhesively placed over the center portion of steering wheel face at the bottom, and on the top side it includes a metal plate at its center portion. The metal plate on the base provides a quick connect/disconnect feature for the rotatable platform via its bottom magnet. The rotatable platform comprising a top flat surface which includes a quick connect fastener such as hooks and loops or clips, or strong type of a magnet for propose of holding a handheld device, a ball bearing at bottom end, and a small weight at the other end of the bottom portion. It may also have a roller at its bottom for contacting with steering wheel surface for propose of smooth rolling over the steering wheel surface. Once the holder is placed onto the steering wheel, the handheld device attachably placed over to the rotatable platform of the holder. The device is designed to hold its position regardless of which direction the steering wheel is being turned and it does not interfere with any direction of steering.

The appended preferred embodiment of this invention is described in FIGS. 10-18 which has been appended after the provisional filing. Briefly, the holder apparatus includes a base on which a wheel (or a ball bearing) is attached, by means of a shaft. The shaft is the integral part of the base. The bottom of the base is adhesively placed over the center portion of the steering wheel. The rotatable wheel is independent of the shaft, on top of which it is mounted and can rotate in either direction. This embodiment makes the steering wheel and the rotatable wheel independent of each other and either one can rotate in either direction without interfering with each other. The rotatable wheel, acts as the receiving part of the clip-on assembly, which is comprised of the rotatable wheel and the platform. The platform has housing for the rotatable wheel and snaps on the rotatable wheel with simply with a light manual pressure. Therefore, the platform is secured onto the rotatable wheel and will not come off passively.

It is also an object of this invention to use a wider platform to hold other devices such as a mini laptop or a makeup case with a mirror.

It is yet another object of present invention to connect holder's base to steering wheel via straps. These straps are sewn to the base which eliminates the adhesive at the bottom of the base. The base with straps is secure to steering wheel's center portion. Once base is secured, the rotatable platform is attach ably connects to the base.

Further objects and advantages of this invention will become apparent from consideration of the drawings and descriptions that follow.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a handheld device holder showing the present invention.

FIG. 2 is an exploded view of the handheld device holder.

FIG. 3 is a section view taken along line 3-3 in FIG. 1.

FIG. 4 is showing a top view of handheld device holder in normal position with respect to steering wheel position.

FIG. 5 is similar view to FIG. 4, but the steering wheel is in rotated position.

FIG. 6 is a top view of handheld device with alternative embodiment of rotatable platform.

FIG. 7 is a top view of handheld device holder base with alternative strap connection to steering wheel.

FIG. 8 is a similar view to FIG. 7, but the base's straps are wrapped differently.

FIG. 9 is a cross section view similar to FIG. 3, but the base shown with straps.

FIG. 10 is the preferred appended embodiment of present invention which shows the handheld device holder on the steering wheel.

FIG. 11 is an exploded view of the preferred embodiment of the handheld device holder.

FIG. 12 is the section view of the preferred embodiment along the line of 4-4 in FIG. 10.

FIG. 13 is the exploded view of the platform and the rotatable wheel in the preferred embodiment.

FIG. 14 is showing the platform and the rotatable wheel engaged, via snap-on fashion, in the housing section of the platform utilizing a spring plunger pin on either side.

FIG. 15 is showing the cross section of the platform and the rotatable wheel in fully engaged position taken along the line of 8-8

FIG. 16 is showing the cross section of the platform and the rotatable wheel in fully engaged position along the line of 9-9.

FIG. 17 is showing the platform secured to the back of the handheld device via loops and hooks.

FIG. 18 is showing the front view of the handheld device along with the top portion of the platform attached to the back of the platform via hooks and loops.

### DETAILED DESCRIPTION OF THE INVENTION

Detailed descriptions of the embodiments and appended preferred embodiments are provided herein. It is to be understood, however, that the present invention may be embodied in various forms. Therefore, the specific details disclosed herein are not to be interpreted as limiting, but rather as a basis for the claims and as a representative basis for teaching one skilled in the art to employ the present invention in virtually any appropriately detailed system, structure or manner.

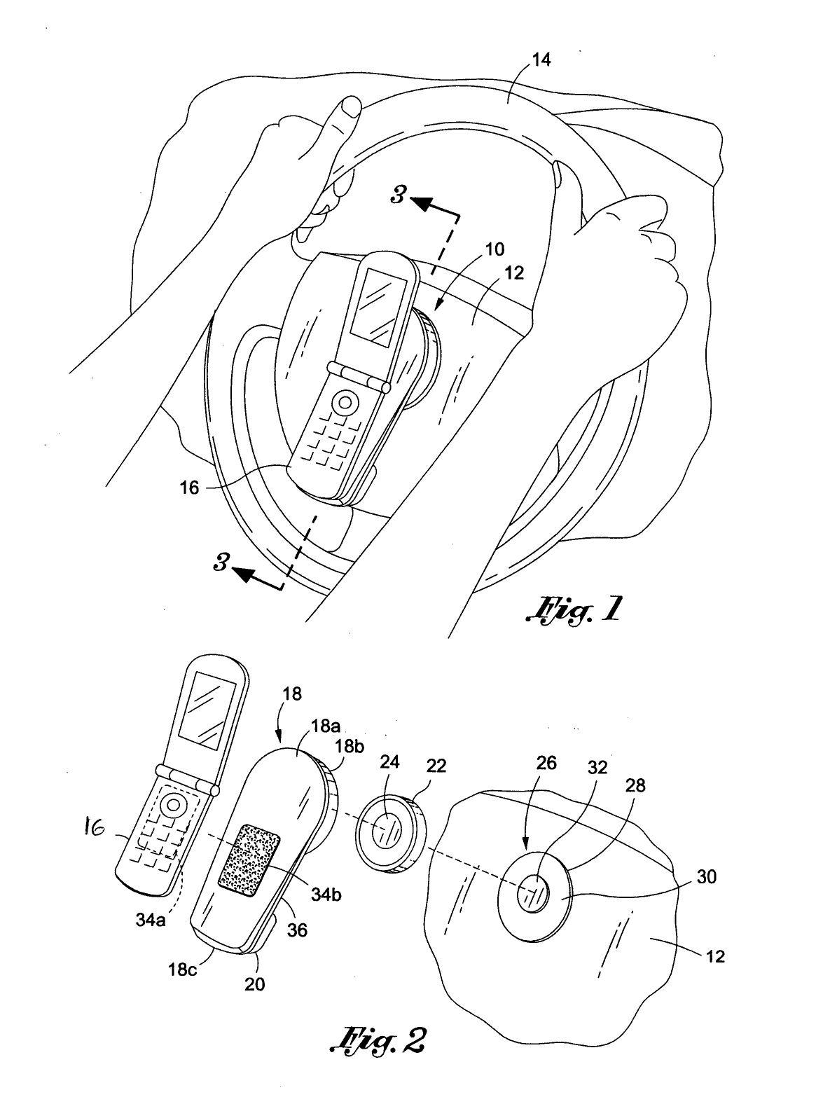

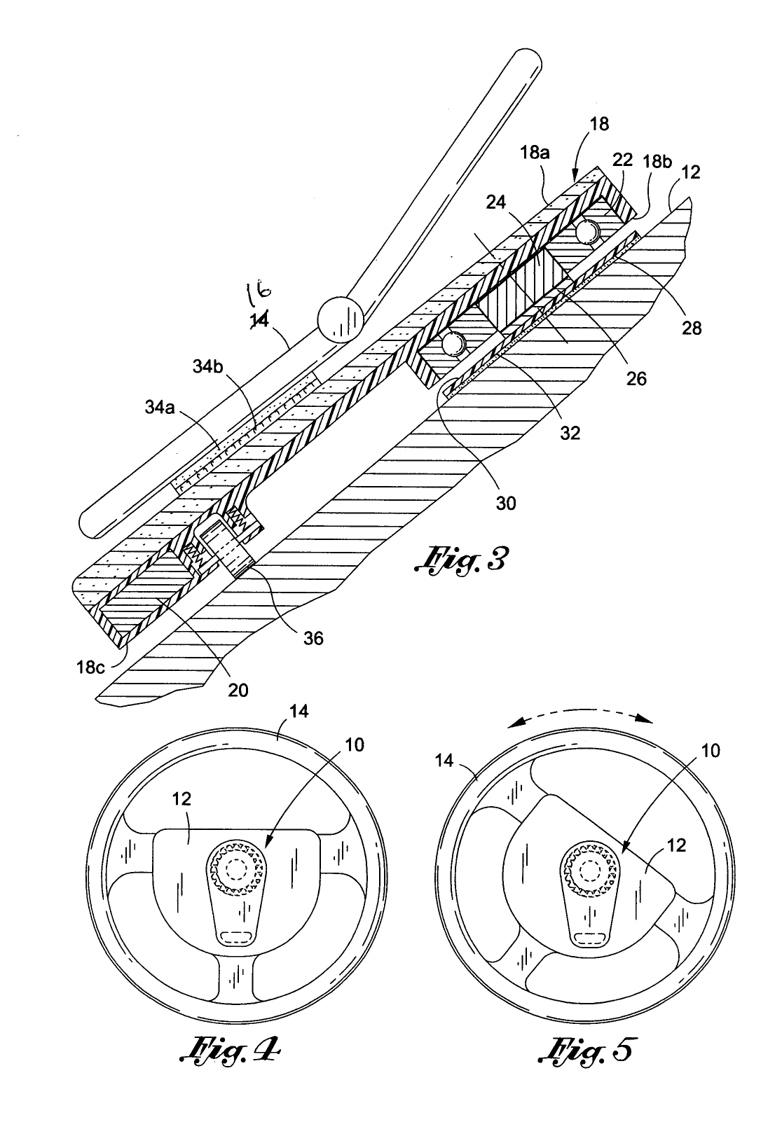

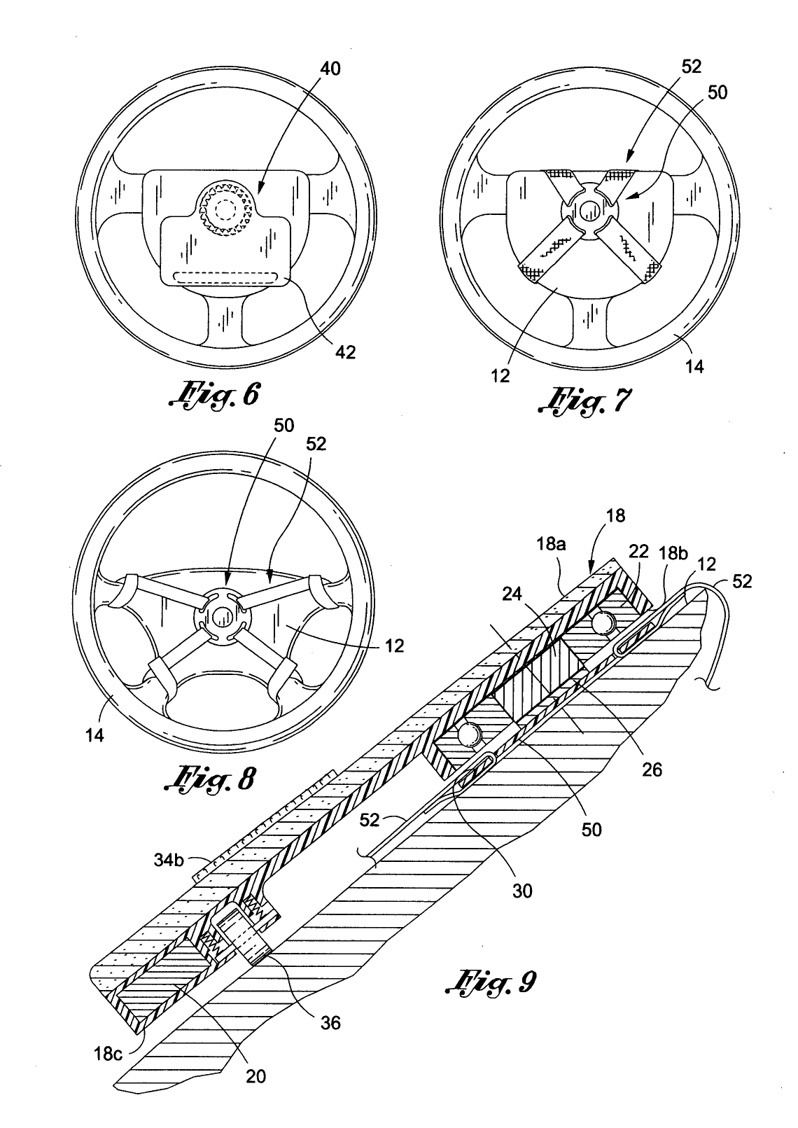

FIG. 1-3 are illustrating a handheld device holder 10 attached to the center portion 12 of vehicle's steering wheel 14. This device holder provides hands free operation for the cell phone 16 in which the driver's hands fully positions on steering wheel 14 and driver have full attention to the road while driving. The holder apparatus 10 include a rotatable platform 18 which attachably connected to a base 26 via a magnet 24. The base bottom side 28 is adhesively placed over the center portion of steering wheel face 12 and on its top side 30 it includes a metal plate 32. The metal plate 32 on the base 26 provides a quick connect/disconnect feature for the rotatable platform 18 via its bottom magnet 24. The rotatable platform 18 comprising a flat surface 18a which includes a quick connect fastener 34a, 34b such as hooks and loops, clip, or magnet for propose of holding a handheld device 14 securely, a ball bearing 22 at bottom end 18b, and a small weight 20 at the other end of the bottom portion 18c. It may also have a roller 36 at its bottom 18c for contacting with steering wheel surface 12.

Once the holder 10 is placed onto the steering wheel face 12 via its base 26, the handheld device 16 is fastening to rotatable platform 18. After handheld placement over the holder, the device is designed to hold its position regardless of which direction the steering wheel is being turned and it does not interfere with any direction of steering as shown in FIGS. 4 & 5. The small weight 20 at the bottom of the holder's platform creates an inertia and minimize any movement with turning wheel due to any residual friction between the small wheel and the base of the steering wheel when it is not being used, thus staying in vertical right side up position. And the small wheel bearing securing the vertical position of the phone, while the steering wheel is being turned in any direction.

The overall device is low in profile and thin enough not to interfere when turning the wheel. Especially when it is used for backing up or making a U turn.

Another advantage of this device is that the driver does not have to turn his or her head any direction to locate or use the phone the head hold its appropriate position of looking forward and viewing central and periphery of the road. The mounted handheld device 16 on the holder is readily accessible and no effort is needed to hold it for dialing, or answering. It is the closest and most direct distance of any position of the phone while being secured in the car for use of conversing with speaker at “ON” position, in which provides clear sound with respect to driver's direct and close position to the handheld device. Easy hands free dialing is also a safe feature of using this type of holder analogous to utilizing other standard modules already part of the standard modern steering wheels.

Furthermore, the degree of eyes away from the road is minimum of all position of dialing while driving. Even in the vehicles equipped with wireless ear piece, where one still has to push the buttons to dial, thus taking the phone either in hand or if on the dash, the driver has to turn head and to the side to locate the phone and to be able to dial. Most people hold the phone in hand, even though they either have a remote ear piece for their handheld device or ear peace with wire, to dial or to push buttons to answer.

Another embodiment of present invention is showing in FIG. 6. This holder apparatus 40 has a wide platform 42 to cover a variety of other types of carrier such as mirror, make up case & etc. The holder platform can also be designed in a way to be a foldable mini tray which can be unfolded and open into horizontal segments and act as the base for holding the makeup box and the base of the platform acts as a mirror.

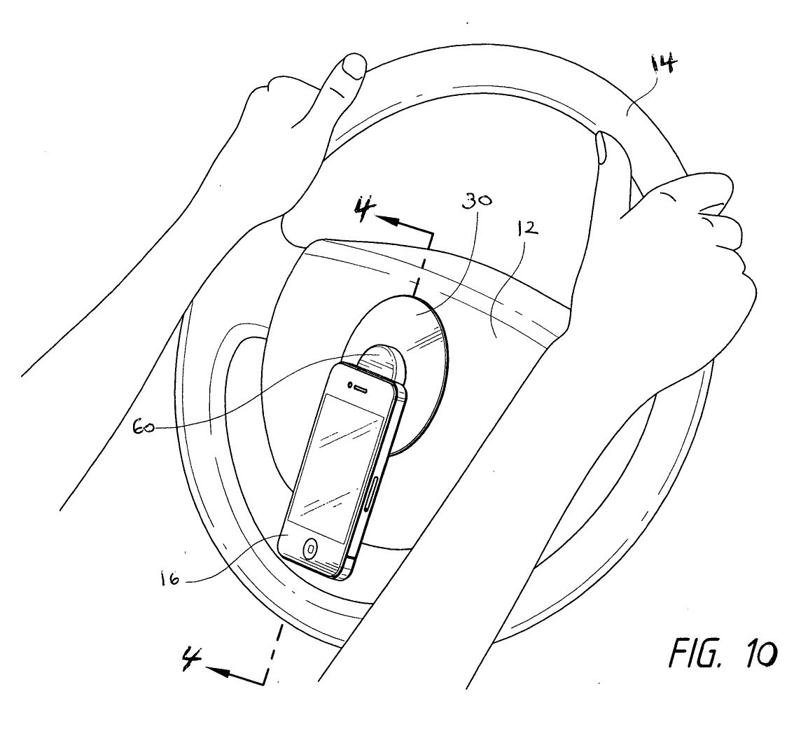

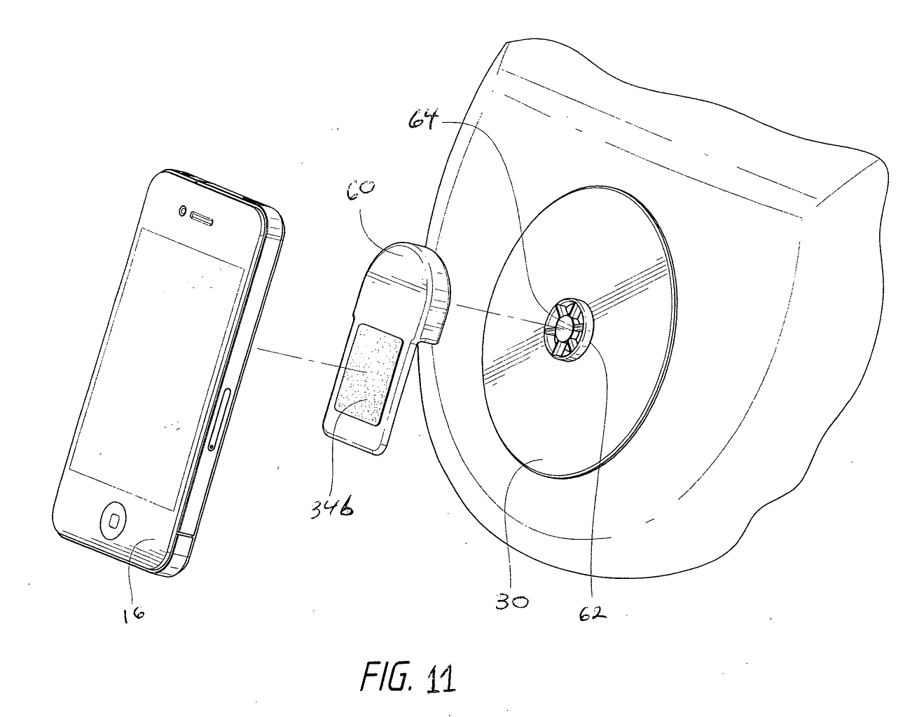

Referring to FIG. 7-9, the holder base 50 is shown alternatively to secure itself without any adhesive to the base. In this embodiment the straps 52 are sewn to the holder's base 50 and wrapped around center portion of steering wheel via hooks & loops. The benefit of this design is that can easily be removed when the holder is not in used.

The appended and preferred embodiment of this invention is described herein. Although, some of the description may be similar, it is to be understood the exemplary detailed variations of the embodiments of the same invention.

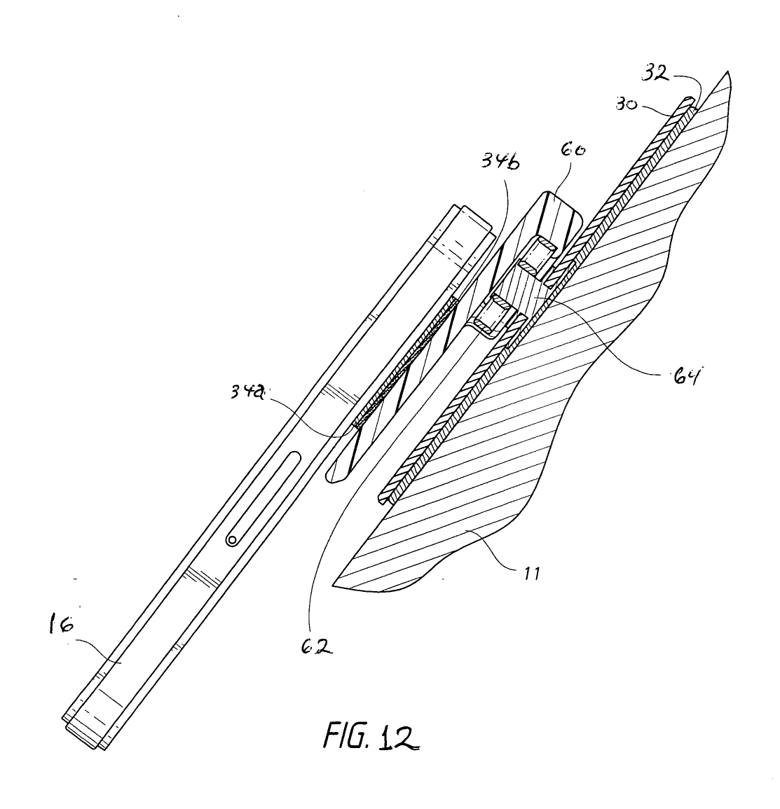

FIG. 10-13 is showing the preferred embodiment handheld device holder base 30 attached to the center portion 12 of steering wheel 14. The holder base 30 includes a rotatable wheel 62 that is mounted on a shaft 64, which in turn is secured to the holder's base 30. The shaft 64 is integral part of the base 30. The base 30 is adhesively 32 attached to the center portion 12 of the steering wheel 14. A hand held device 16 is secured onto platform 60 via hooks 34b, which is adhesively attached to back of the platform 60, and loops 34a, which is adhesively attached to the back of handheld device 16.

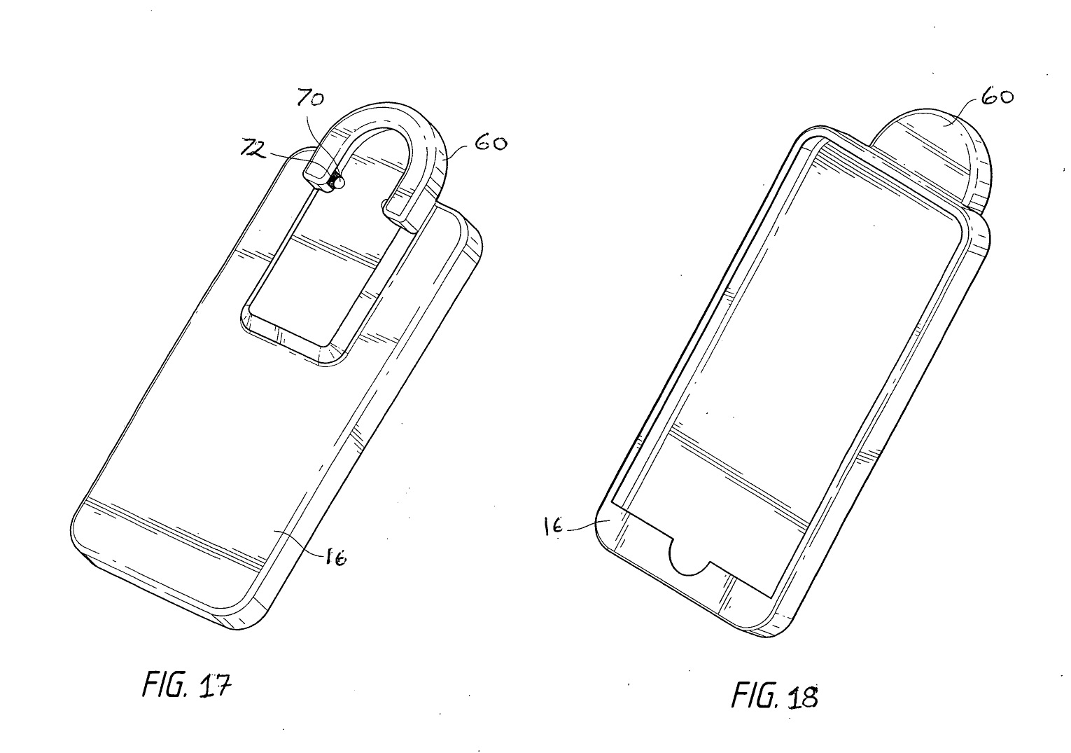

Once the handheld device is reversibly secured onto the platform 60, as shown in FIGS. 17, and 18, it then could be clipped onto the rotatable wheel 62.

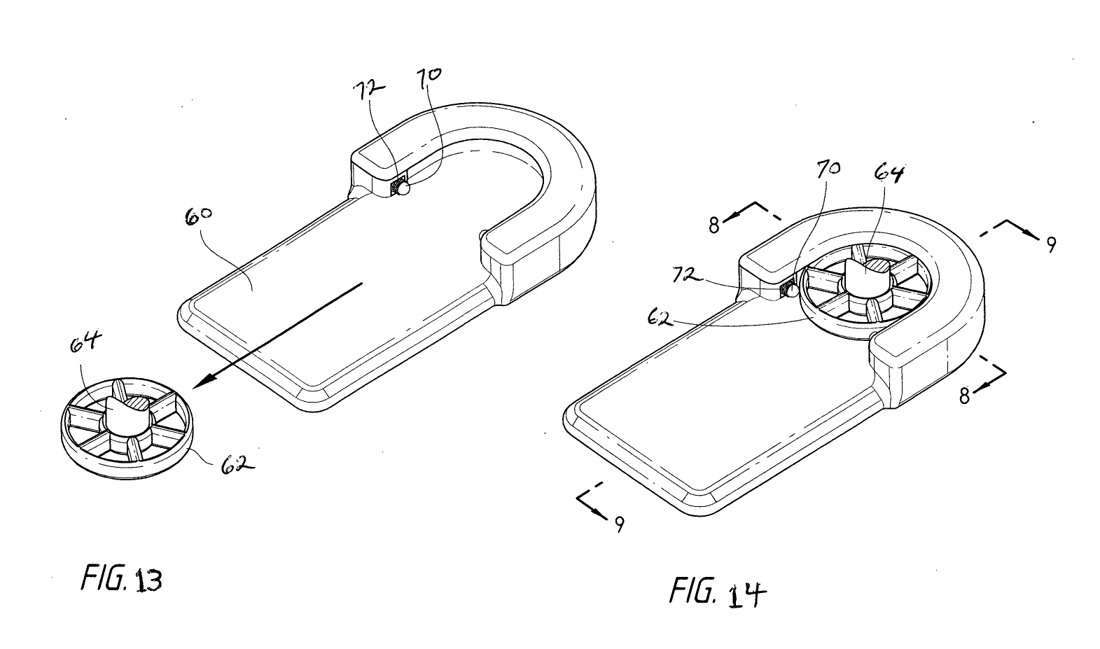

FIGS. 13 and 14 show in detail the appended and preferred embodiment, where the process of securing the platform 60 onto the rotatable wheel 62 secured via spring 72 loaded plunger pin 70 on either side of the entry point of the rotatable wheel, is shown. In addition, the housing portion of the platform 60 provides stability and retention for the handheld device 16 so that the handheld device maintains it position parallel to or tangential to the surface of the center of the steering wheel 14 and does not require the small wheel 36 (as mentioned earlier in the initial embodiment) at the bottom of the platform 60.

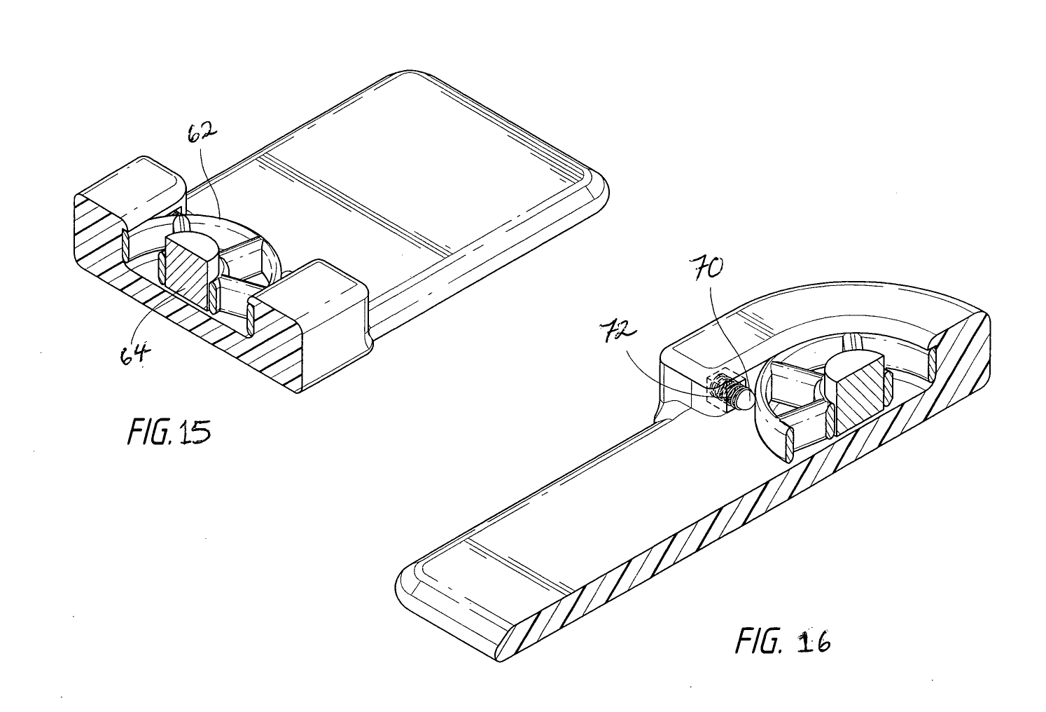

FIGS. 15 and 16 show the cross sections of the mounted and engaged platform 60 and rotatable wheel 62. In a fully “clipped-on” position, the platform 60 is secured onto the rotatable wheel 62 via spring loaded 72 plunger pin 70, insuring that the platform and consequently the handheld device 16 attached to the platform 60 will not come off accidentally or passively while driving. The relationship between the platform 60 and a handheld device is demonstrated in FIGS. 17 and 18. Positioning and attaching the platform 60 via hooks and loops to the back and top portion of the handheld device 16 insures that the handheld device weight insures it vertical position while mounted on the rotatable wheel 62.

While this invention is susceptible of embodiments in many different forms, this specification and the accompanying drawings disclose only some specific forms as examples of the invention. The invention is not intended to be limited to the embodiments so described; however, the scope of the invention is pointed out in the appended claims.

I claim:

1. A handheld device holder to be used in conjunction with vehicle's steering wheel comprising:
A platform, where the said platform's top surface hold the handheld device and on the bottom side of the platform there is a housing that clips the platform onto a rotatable wheel; said rotatable wheel is mounted on the center of a base via a shaft, where the said shaft is an integral part of a base. The said base bottom side is adhesively attached to the surface of the central portion of the vehicle's steering wheel. The unique interaction of the base, the rotatable wheel, and the platform allows the handheld device to remain in its vertical original position while the steering wheel is turned in either direction.

2. A handheld device holder according to claim 1, wherein said platform can be built into the protective covers for the available handheld devices as one piece. Thus, the said handheld device available soft and hard covers act as the said platform.

3. A handheld device holder according to claim 1, wherein the base and the rotatable wheel components of the holder apparatus can be built into the center of the steering wheel by the vehicle's manufacturers as a standard feature for securing, and utilizing handheld devices hands free.
